(19) United States
(12) Patent Application Publication
(10) Pub. No.: US 2013/0156987 A1
(43) Pub. Date: Jun. 20, 2013

(54) MULTILAYER MATERIAL, METHOD FOR PRODUCTION THEREOF AND PRINTING STOCK PRODUCED THEREWITH

(71) Applicant: Jules Fischer, Oberholz-Lieli (CH)

(72) Inventor: Jules Fischer, Oberholz-Lieli (CH)

(73) Assignee: Fofitec AG, Dottikon (CH)

(21) Appl. No.: 13/331,369

(22) Filed: Dec. 20, 2011

(51) Int. Cl. B65D 65/28; B32B 38/00; B32B 7/02

(52) U.S. Cl. 428/43; 428/213; 156/192

(57) ABSTRACT

A multilayer material is provided in a continuous form on a roll having two bearing cover layers and an amorphous coating substance between the cover layers. At least one of the two cover layers is an at least translucent, oriented plastic film and the coating substance contains an adhesive. The multilayer material has an overall thickness (D) preferably in the range of 100-800 μm, and the coating substance contributes at least 30% to this overall thickness. The adhesive contained in the coating substance is activatable at least once by heat and pressure, but is not sticky at room temperature. Methods for producing such a multilayer material and printing stock that is produced using a section of such a multilayer material are also described.

### BACKGROUND OF THE INVENTION

1. Field of the Invention

The present invention relates to a multilayer material having two bearing cover layers and an amorphous coating substance between the cover layers, wherein at least one of the two cover layers is at an at least translucent, oriented plastic film, and wherein the coating substance contains an adhesive. The invention further relates to methods for producing such a multilayer material and printing stock produced therewith.

2. Description of the Prior Art

Multilayer materials of the described type are known for example in the form of composite films. In the context of producing such composite films, the term laminating is also used. A typical characteristic of these multilayer materials is that the amorphous coating layer that contains the adhesive, and which usually consists entirely of the adhesive, forms a very thin film that does not substantially contribute to the overall thickness of the multilayer material relative to the covering layers. Accordingly, the properties of the material are determined almost exclusively by the cover layers. The only function served by the coating or adhesive substance is that of bonding the cover layers. The quantity of adhesive is minimized as a cost factor to the extent possible.

In DE 199 60 411, a dispersion adhesive is used as the adhesive for bonding plastic films to produce composite films, and a certain barrier effect is afforded by the adhesive at the same time. After it has been applied and allowed to dry, the adhesive is sticky, which is also necessary for the subsequent lamination. This is referred to as dry lamination. Finally, the adhesive must cure for several days to reach the desired strength.

The use of aqueous dispersions as the hot seal coating is known from EP 0 798 357. A first substrate is coated with this hot seal coating, after which the coating is dried. Accordingly, the coating is not sticky at room temperature. This is important to enable the coated substrates to be stacked without sticking together before they are bonded with an additional substrate. To bond them with an additional substrate, the coated substrates are pressed against it and heat is applied for thermal activation of the hot seal coating. This technique is used in particular in food packaging products, in which case a cover foil is sealed onto the rim of a cup made from deep-drawn plastic film. Here too, the layer thicknesses of the hot seal coating are generally intentionally thin.

A relatively thick multilayer material known from U.S. Pat. No. 6,699,629 B1 is intended to function as a carrier for printed images and combines light weight with the other properties typical for this purpose in terms of stiffness, flatness, smoothness, brilliance, whiteness and opacity. It has a closed cell foam core consisting of a polymer material to which hollow microspheres may be added. For the cover layers, plies of paper or plastic film, preferably biaxially oriented plastic films, are used. In one embodiment, they are laminated on the foam core with the aid of an adhesive. It may be assumed that here too as little adhesive as possible is used.

In other embodiments, one of the cover layers is produced together with the foam core in a single work step, by coextrusion from different materials or by extrusion of the same material, in which case the material is prevented from expanding on one side. The other cover layer is then laminated onto the foam core by using an adhesive.

A form is known from WO 98/26938 in which a card is incorporated in a sheet of paper, the card being produced by congruent punch lines made from opposite sides. The card is attached by an intermediate layer that is not separated by the punch lines and which may be a partial layer of the sheet of paper or a structurally independent layer that is glued to the paper layer. The intention is that it should be possible to detach the card by separating the intermediate layer between the two punch lines. However, it has been found that the forces necessary for this cannot be easily controlled. If they are too great, the card cannot always be detached without destroying it. If they are too weak, there is a risk that the card may be detached from the form too soon, and problems may arise particularly during its passage through the printers.

In the case of forms with integrated cards, attachments are often present on a primary carrier as reinforcement and/or plastification for the cards, or as carrier layers therefor. The primary carrier is usually in the form of a sheet of A4- or letter-size paper. In order to ensure that the overall design of the form is not too thick, too stiff or too heavy, and for reasons of cost, these attachments are usually smaller in terms of area than the primary carrier, and are only locally present in the area of the cards. As a consequence, they result in local thickening, which in turn causes the stack become slanted. This slanting of the stack causes problems in sheetfed printers, as the magazines for these printers can also only be partly filled.

Monolayer thick films having thicknesses of 125 μm or 175 μm for example are also used in the production of cards or similar, particularly if this is required for high stiffness and/or resistance to moisture or similar threats. However, thick foils of such kind, particularly those made from polyester, are relatively expensive and are not always available on the market in sufficient quantities.

### SUMMARY OF THE INVENTION

The object of the invention is to suggest a multilayer material of the type described in the introduction that has practical advantages over the known materials. In particular, the material is intended also to be usable as a substitute for monolayer thick films.

This object is solved with a multilayer material according to the present invention and is correspondingly characterized in that the overall thickness thereof is 100-800 μm, that at least 30% of this overall thickness is constituted by the amorphous coating substance, and that the adhesive contained in the coating substance is able to be activated at least once by heat and pressure but is not sticky at room temperature.

The multilayer material according to the invention is usable as a substitute for monolayer thick films due to its similar properties in use and overall thickness.

In that the coating substance constitutes at least 30% of the overall thickness, it is possible to use relatively thin cover layers. In particular, the plastic film used may be a plastic film that is at least translucent, oriented and having a thickness in the range from 12-75 μm. In this thickness range, the selection of commercially available plastic films is large, and because of the large quantities in which such films are manufactured and consumed, their price is also relatively low. This may make even mean that they are less expensive than monolayer films of corresponding thickness despite the additional processing steps required to produce the multilayer material according to the invention.

The layer thicknesses of these adhesives created particularly for laminating adhesives in composite films according to the prior art, such as are described in DE 199 60 411 A1 are also thin, being only a few μm thick, because they cure relatively slowly. In the case of the composite film described in DE 199 60 411 A1, curing takes at least several days. If the layer thickness of an adhesive of this kind were increased significantly, the composite material could not be rolled up immediately after lamination. The pressure exerted on the composite material on the roll would cause an effect known as telescoping of the material. The present invention avoids this problem by the use of the adhesive in the amorphous coating substance that is able to be activated at least once with heat and pressure. This adhesive will be referred to in the following as thermally activated adhesive. This class of adhesives also includes those referred to as hot seal coatings. Thermally activated adhesives feature extremely high immediate strengths, almost equal to their final strengths. By virtue of this property of the material, the multilayer material is able to be rolled up immediately or even forwarded directly for further processing as it is being produced despite the great layer thickness of the amorphous coating substance.

Many thermally activatable adhesives are commercially available. The basic properties that are of primary importance for the purposes of the invention are good adhesion on one of the two cover layers by coating, and adhesive strength with the opposite cover layer under pressure and heat, or also with a corresponding coating thereon.

The adhesive contained in the coating substance is based for example on acrylate, polyurethane, polyester, epoxy resin, ethylene vinyl acetate, ethylethylene acrylate, or combinations thereof.

It is important that the thermally activated adhesive is not sticky at room temperature, so that the borders or cutting edges of the multilayer material according to the invention cannot adhere to other objects or to the material itself on the roll or in a stack. This also prevents adhesive from seeping out at the edges.

To ensure the multilayer material is able to withstand thermal loads, such as occur for example during printing in a laser printer, the activation temperature of the thermally activated adhesive should be higher than 80° C., and preferably even higher than 100° C.

One of the two cover layers of the multilayer material according to the invention is an at least translucent, oriented plastic film. A plastic film is at least translucent if it is transparent, though the transparency does not need to be especially clear. The plastic film may be a polyester film, a polypropylene film, a polycarbonate film or a polyamide film, for example. In particular, it might also be a film produced from different materials by coextrusion.

The other cover layer may be a film of the same kind, or a metal film, or a paper layer. Because the plastic film is oriented before it is incorporated in the multilayer material, its dimensional stability (tear strength and stretch resistance) at room temperature as well as under thermal load is increased.

At least one of the cover layers, preferably the one on the outside, may be provided with a print layer and/or a heat reflecting layer and/or be constructed as a membrane.

The two cover layers together preferably represent not more than 150 of the overall thickness.

The coating substance also preferably joins the two cover layers to one another directly. A functional layer may be present between the two cover layers, preferably between two plies of the coating substance, but possibly additionally covering a partial area thereof.

The coating substance may preferably be made less dense, stiffer, more opaque, whiter, more or less thermally insulating and/or electrically conductive or flame retardant, have stronger or weaker antibacterial properties, contain, absorb or emit more or less liquids or fragrances, and/or be made more or less chemically reactive by adding at least one substance to the adhesive.

The coating substance may contain 25-69% by weight, preferably 39-56% by weight adhesive and 31-75% by weight, preferably 44-61% by weight admixtures to the adhesive relative to its dry weight.

The admixtures to the adhesive comprise mainly bulking agents, particularly carbonates such as calcium carbonate, oxides such as titanium dioxide and zinc oxide, silicates such as kaolin and talc, sulfates such as barium sulfate, fibers such as glass fiber and/or lightweight fillers such as hollow microspheres made of glass or plastic. The latter serve to lower the density of the coating substance and thus also to reduce the overall weight of the multilayer material.

If the coating substance has a tear strength at room temperature not exceeding 25% of the average tear strength of the cover layers, but preferably a tear strength of 2.5-4.5 N/mm², the multilayer material according to the invention is particularly suitable for use for printing stock with an integrated punched part as described in the claims. Such a printing stock, in which the integrated punched part is created by at least partially congruent indentations in the multilayer material that cut through the two cover layers completely but cut the coating substance only partially, leaving a remaining thickness of 25 μm, and which is kept attached to the surrounding material by the remaining thickness in the bond, is also an object of the present invention.

If the multilayer material according to the invention is separable in itself, it is particularly suitable for use for a printing stock comprising at least two flat partial print stock items joined in coplanar manner as described below. Such printing stock, in which the multilayer material is less thick along a border strip than over the remaining area thereof, in which the other partial print stock item is less thick along a border strip than over the remaining area thereof, and in which the multilayer material and the other partial print stock item are adjoined to one another along the their respective border strips, is a further object of the present invention.

The bending stiffness at room temperature of the multilayer material according to the invention is preferably also equal to at least 70% of the bending stiffness that would be exhibited by one of the two cover layers, preferably the plastic film, if it had the same overall thickness. In this case, the multilayer material is particularly suitable for use as a substitute for a monolayer film having the same overall thickness.

The amorphous coating substance that contains the thermally activated adhesive may be produced and processed in three different systems within the scope of the invention: as a liquid or paste-like coating substance on an aqueous base, as a liquid or paste-like coating substance on a solvent-containing base, or as an extrudable coating substance.

A preferred method for producing the multilayer material according to the invention is indicated hereinafter. According to this, both cover layers are unrolled from a roll as continuous webs. The amorphous coating substance is then applied in liquid or paste form to at least one of the two running cover layer webs and is then dried out with the aid of heating. Drying causes the coating substance to solidify. Alternatively, it may be applied hot as extrudate, in which case drying is not necessary.

In the dried state, the coating substance and the adhesive contained therein is not sticky at room temperature. It does not become sticky until the thermally activated adhesive contained therein is heated up to its activation temperature. When the adhesive is in the activated state, the two cover layers are bonded to one another by the application of pressure. Upon cooling to below the activation temperature, the adhesive and therewith also the coating agent overall reaches sufficient strength within a very short period, so that the multilayer material according to the invention may be wound onto a roll or otherwise processed further almost immediately after the two cover layers have bonded with one another. Further processing may take the form of coating, cutting into narrow rolls or cutting to size, stamping or printing.

Bonding of the two cover layers preferably proceeds while the coating substance is still hot from the drying or extrusion process. This then advantageously reduces the quantity of heat required to activate the adhesive and the time required therefor. If the coating substance is extruded, additional activation may possibly be entirely dispensed with.

One ply of the coating substance is preferably applied to each of the two cover layers, also preferably directly. The immediate advantage of this is that each application is less thick and is able to be dried more quickly and more effectively in the aqueous and solvent-containing systems. In this way, a good bond is already created between the plies of the coating substance and the cover layers even during drying, and the activation of the adhesive then essentially serves only to bond the two plies of the coating substance to one another subsequently.

### BRIEF DESCRIPTION OF THE DRAWINGS

In the following, the invention will be explained in greater detail with reference to exemplary embodiments thereof and in conjunction with the drawing. In the drawing:

FIG. 1 is a sectional representation of an embodiment of a multilayer material according to the invention;

FIG. 2 shows a schematic drawing indicating method for producing the multilayer material of FIG. 1;

FIG. 3 shows another schematic drawing indicating further method for producing the multilayer material;

FIG. 4 inset a) shows a plan view of a portion of printing stock made from a multilayer material according to the invention with an integrated card, inset b) shows the printing stock along a section (I-I) and inset c) shows the same view of the printing stock with the card detached;

FIG. 5 shows cross sectional views, in inset a) of a portion of a partial print stock item made from a multilayer material according to FIG. 1 having a border strip of reduced thickness, in inset b) of a portion of a partial print stock item made from paper, also having a border strip of reduced thickness, and in inset c) of printing stock comprising the two partial print stock items joined in coplanar manner;

FIG. 6 inset a) shows a cross sectional view of a pressing plate for compressing a continuous partial print stock item made from paper, and inset b) shows a plan view of the pressing plate;

FIG. 7 shows a cross sectional view of an embodiment of a multilayer material according to the invention with an additional print layer;

FIG. 8 shows a cross sectional view of an embodiment of a multilayer material according to the invention with an additional adhesive layer; and

FIG. 9 shows a cross sectional view of an embodiment of a multilayer material according to the invention with an additional functional layer.

The figures are diagrammatic, and particularly the layer thicknesses are highly exaggerated.

### DETAILED DESCRIPTION OF THE PREFERRED EMBODIMENTS

Multilayer material 1 of FIG. 1 comprises two bearing cover layers 10, 20 and an amorphous coating substance 30 between these cover layers. The attributes “bearing” with regard to the cover layers and “amorphous” with reference to the coating substance describe the respective states thereof at the moment the coating substance is applied, as will be described in greater detail later. The two cover layers 10, 20 are for example transparent, oriented plastic films made from polyester. Due to the orienting process, they are relatively dimensionally stable even at elevated temperatures. Coating substance 30 contains a thermally activated adhesive, is white or colored and opaque, and bonds the two cover layers 10, 20 directly with one another.

Total thickness D of the multilayer material of FIG. 1 is 175 μm and is thus in the range of relatively thick monolayer films, such as are used for cards and other items. The two cover layers 10, 20 each have a thickness d1 and d2 of just 50 μm and coating substance 30 or the layer formed thereby has a thickness d3 of 75 μm. The coating substance thus constitutes a significant fraction of total thickness D. In contrast, thicknesses d1, d2 of the two cover layers 10, 20 are within the range of thicknesses for normal utility films. Together, the two cover layers 10, 20 should not account for more than 150 μm of total thickness D. Even added together, the two cover layers 10, 20 are still substantially less expensive than a 175 μm thick, opaque polyester monolayer film, not least due to their transparency (no need for opacity agents such as expensive titanium dioxide) and the considerably greater volumes in which films are consumed.

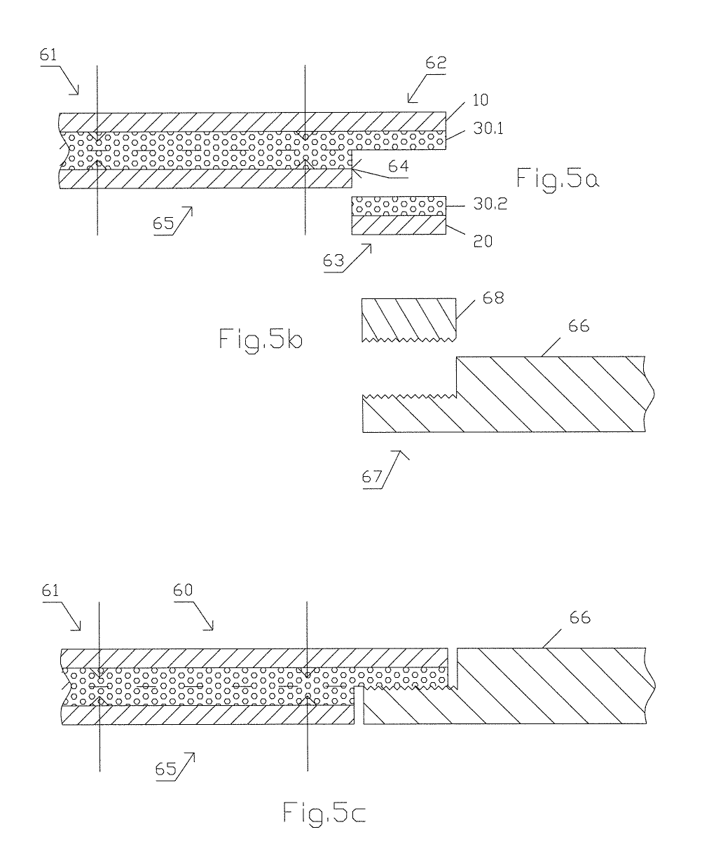

As was described previously, coating substance 30 contains a thermally activated adhesive and admixtures to the adhesive. The adhesive is manufactured for example with a base of acrylate, polyurethane, polyester, epoxy resin, ethylene vinyl acetate (EVA) and/or ethylethylene acrylate (EAA). It is not sticky at room temperature, but is activated by heating above room temperature and applying pressure. It constitutes between 25-69% by weight, preferably 39-56% by weight of the dry weight of coating substance 30. Correspondingly, the fraction of admixtures is from 31-75% by weight, preferably 44-61% by weight, and is thus relatively high, which is not usual for laminating adhesives. The admixtures reduce the adhesive strength of the overall mixture of coating substance 30. The adhesive strength may be adjusted to a certain degree by appropriate selection of the adhesive and the proportion of admixtures. If the adhesive strength is kept quite low, it is possible to lend the multilayer material a property of inherent separability, which may be advantageous in certain applications, as will be explained with reference to FIG. 5.

The admixtures are at least mostly particulate bulking agents, and in this context carbonates such as calcium carbonate, oxides such as titanium dioxide and zinc oxide, silicates such as kaolin and talc, sulfates such as barium sulfate, fibers such as glass fibers and/or lightweight fillers such as hollow glass or plastic microspheres are particularly practical. The bulking agents are finely distributed in the adhesive, and the adhesive forms a matrix of sorts for the bulking agents. The bulking agents add to the volume of coating substance 30 and are responsible for the opacity thereof indicated above. A bright white may be achieved by the addition of titanium dioxide. Lightweight fillers such as the hollow microspheres add increase the volume considerably without significantly increasing the weight. In this way, the coating substance helps to keep the density of the multilayer material advantageously low. The bending stiffness of the multilayer material and/or the tear strength of coating substance 30 may also be varied and adjusted by appropriate selection of the bulking agents.

### EXAMPLES OF COATING SUBSTANCE COMPOSITIONS

The first component listed in each of the following examples is used as the adhesive.

A. Aqueous Coating Substances (with at Most a Small Fraction of Solvent<5%)

### Example A.a

| | Density | % by | % by |
|---|---|---|---|
| Components | [g/cm³] | weight dry | volume |
| #7 Hycar 26084 | 1.00 | 50.50 | 50.50 |
| #5 Calcite MX10 | 2.72 | 37.90 | 13.96 |
| #3 Tiona 595 | 4.10 | 9.30 | 2.27 |
| Overall density/Total | 1.46 | 97.7 | 66.73 |

Component #7 is purely aqueous on a carboxy-modified acrylate base and adheres well to various cover layers. A degree of crosslinking is achieved even without the addition of a crosslinking agent, creating increased chemical stability and mechanical strength. Overall density is relatively high at 1.46, and is therefore not very economical for most applications.

### Example A.b

| | Density | % by | % by |
|---|---|---|---|
| Components | [g/cm³] | weight dry | volume |
| #8 Alfa VP 58/405 | 1.10 | 44.50 | 40.45 |
| #2 Kaolin K1 | 2.60 | 33.40 | 12.85 |
| #3 Tiona 595 | 4.10 | 9.50 | 2.32 |
| #4 Q-Cel 5020 | 0.20 | 11.10 | 55.50 |
| Overall density/Total | 0.89 | 98.5 | 111.12 |

Component #4 comprises hollow glass microbeads. This component is responsible for lowering the overall density to a more economical value of 0.89. Component #8 is used as an aqueous polyurethane hot sealing coating to bond the cover layers.

### Example A.c

| | Density | % by | % by |
|---|---|---|---|
| Components | [g/cm³] | weight dry | volume |
| #9 Michem Flex 1852 | 1 | 44 | 44 |
| #2 Kaolin K1 | 2.6 | 32.9 | 12.65 |
| #3 Tiona 595 | 4.1 | 9.5 | 2.32 |
| #4 Q-Cel 5020 | 0.2 | 11.1 | 55.5 |
| Overall density/Total | 0.85 | 97.5 | 114.47 |

In this cast, component #9 serves as the adhesive.

### B. Solvent-Containing Coating Substances

### Example B.a

| | Density | % by | % by |
|---|---|---|---|
| Components | [g/cm³] | weight dry | volume |
| #1 Rotoflex L-130 | 0.90 | 50.00 | 55.56 |
| #5 Calcite MX10 | 2.72 | 41.20 | 15.17 |
| #3 Tiona 595 | 4.10 | 8.80 | 2.15 |
| Overall density/Total | 1.37 | 100 | 72.88 |

Component #1 is a hot sealable coating agent that adheres to and seals polyester cover layers particularly effectively. Component #5 improves opacity and thermal resistance better than component #3, but yields poorer results regarding optical properties. Overall density of is again relatively high at 1.37.

### Example B.b

| | Density | % by | % by |
|---|---|---|---|
| Components | [g/cm³] | weight dry | volume |
| #1a Rotoflex L 120-20 | 0.87 | 50.00 | 57.47 |
| #2 Kaolin K1 | 2.60 | 30.10 | 11.58 |
| #3 Tiona 595 | 4.10 | 8.80 | 2.15 |
| #4 Q-Cel 5020 | 0.20 | 11.10 | 55.50 |
| Overall density/Total | 0.79 | 100 | 126.69 |

In this example, the addition of the glass microbeads in component #4 serves to lower the overall density and at the same time increase opacity and stiffness. Component #1a is used as the adhesive with better adhesion and sealing on oriented polypropylene film.

### C. Extrudable Coating Substances

### Example C.a

| | Density | % by | % by |
|---|---|---|---|
| Components | [g/cm³] | weight dry | volume |
| #10 Amplify EA 100 | 0.93 | 46.00 | 49.46 |
| #5 Calcite MX10 | 2.72 | 45.00 | 16.57 |
| #6 TiPure R-350 | 4.10 | 9.00 | 2.20 |
| Overall density/Total | 1.47 | 100 | 68.23 |

In this example, component #10 (Amplify EA 100 ethylene ethyl acrylate (EEA)) provides good adhesion for a very wide range of cover layers. Component #6 was developed especially for extrusion and provides good opacity and UV stability. Component #5 serves as the bulking agent and enhances opacity and thermal stability.

However, the overall density of 1.47 is not economically advantageous.

### Example C.b

| | Density | % by | % by |
|---|---|---|---|
| Components | [g/cm³] | weight dry | volume |
| #11 Amplify VA 400 | 0.93 | 46.00 | 49.57 |
| #5 Calcite MX-10 | 2.72 | 30.90 | 11.36 |
| #6 TiPure R-350 | 4.10 | 4.00 | 0.98 |
| #4 Q-Cel 7023 | 0.23 | 15.10 | 65.65 |
| Overall density/Total | 0.78 | 100 | 127.56 |

The addition of glass microspheres (4) having diameters in the range of 45 μm and a density of 0.22 results in a density almost half of that of example C.a. In addition, this addition also increases bending stiffness and improves opacity. In this case, component #11 is an extrusion lamination adhesive with an EVA base and adheres to many cover layers.

| Suppliers | |
|---|---|
| #1, #1a | Rotoflex AG, Lebernstrasse 40, CH-2540 Grenchen |
| #2 | Alberto Luisoni AG, General Wille Strasse 201, |
| | CH-8706 Feldmeilen |
| #3 | As above for titanium dioxide |
| #4 | As above for glass microspheres |
| #5 | As above for calcium carbonate calcite |
| 36 | DuPont de Nemours International S.A. DuPont Titanium |
| | Technologies, Ketenislaan 1 ‘Singelberg’ Haven 1548, |
| | B-9130 Kallo |
| #7 | Lubrizol Advanced Maetrials, Inc., Chaussee de Wavre 1945, |
| | B-1160 Brussels |
| #8 | Alfa Klebstoffe AG, Vor Eiche 10, CH-8197 Rafz |
| #9 | Keyser & Mackay, Badenerstrasse 587, CH-8048 Zurich |
| #10 | Dow Belgium B.V.B.A., Prins Boudewijnlaan 41, |
| | B-2650 Edegem |
| #11 | As above |

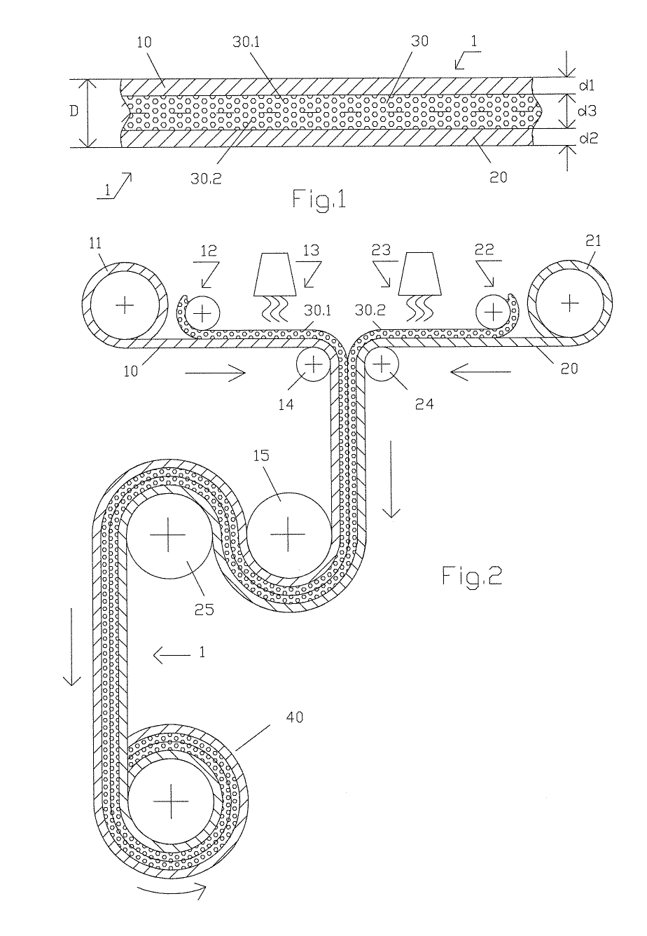

FIG. 2 illustrates a method for producing a multilayer material 1 as shown in FIG. 1 using a coating substance in a liquid or paste-like form, such as one of the examples of type A or B. Both cover layers 10 and 20 are unwound in the form of continuous webs from a roll 11 and 21 and fed to a coating system 12 and 22, where a ply 30.1 and 30.2 of the coating substance described in the preceding is applied to each in liquid or paste-like form, for example in accordance with one of the examples of type A or B described above. The coating systems may be rollers, as illustrated in FIG. 2, or also cold dies in contact with 10 and 20 or at a distance (curtain coating).

Components dissolved in organic solvents and any other additives may be added before the application, either in batches or by inline, continuous feed, and then homogenized.

The two plies 30.1 and 30.2 of the coating substance are dried in drying units at 13 and 23 by the application of heat (for example with hot air). If the coating substance is a water-based substance, the water is evaporated, if the coating substance has a solvent-containing base, the solvent is evaporated. Then, the two cover layers coated in this way are brought into contact with one another and pressed together by a heated roller 14 and a counter roller 24. The heat applied via roller 14 activates the adhesive contained in the two plies 30.1 and 30.2 of the coating substance, so that both plies are joined in a mutual bond and stick to one another. The layer of coating substance 30 having thickness d3 as shown in FIG. 1 is created. The boundary surface between two plies 30.1 and 30.2, from which this layer is obtained via the method of FIG. 2, is indicated in FIG. 1 by a dashed line. Of course, an adhesive bond is also created between the two cover layers 10, 20 and coating substance 30, and this is formed at least in part beforehand, particularly when the two plies 30.1 and 30.2 are drying. This adhesion will usually be even stronger than the bond between the two plies, which is highly advantageous and may also be used for the benefit of the function as will be described in the following. Multilayer material 1 obtained in this way is finally wound onto a roller 40 in the same pass in preparation for subsequent use. Alternatively, it might also be processed further immediately. Winding onto the roll or further processing are both possible because the multilayer material has already reached its full bonding strength immediately after it has cooled to room temperature. Cooling may be supported and accelerated by the use of chill rollers 15, 25 after roller pair 14, 24.

The distance between drying units 12 and 22 and roller pair 14, 24 is selected with consideration for the running speeds of the two cover layer webs such that they and particularly the two plies 30.1 and 30.2 of the coating substance are still hot when they are brought into contact with one another, so that only a little additional heat has to be applied in addition to the heat generated by rollers 14, 24 in order to activate the adhesive in the coating substance, thus saving energy. On the other hand, the distance between rollers 14, 24 and roller 40 must be of such a size that the adhesive in the coating substance has sufficient time to cool down to below its activation temperature and thus solidify again before it reaches roll 40, so that the multilayer material is strong enough to enable it to be wound up. This distance may be reduced if chill rollers 15, 25 are used.

Coating substance 30 might also be applied only to one side in the method of FIG. 2, that is to say with full layer thickness d3 to one of the two cover layers 10, 20. In this context, it would be advantageous in that only one coating system 12 or 22 and one drying station 12 or 22 were necessary. It would be disadvantageous in that the double-thick layer would be dried less effectively and it might be necessary to make allowance for a longer drying time by lengthening the drying section and/or slowing the web speed.

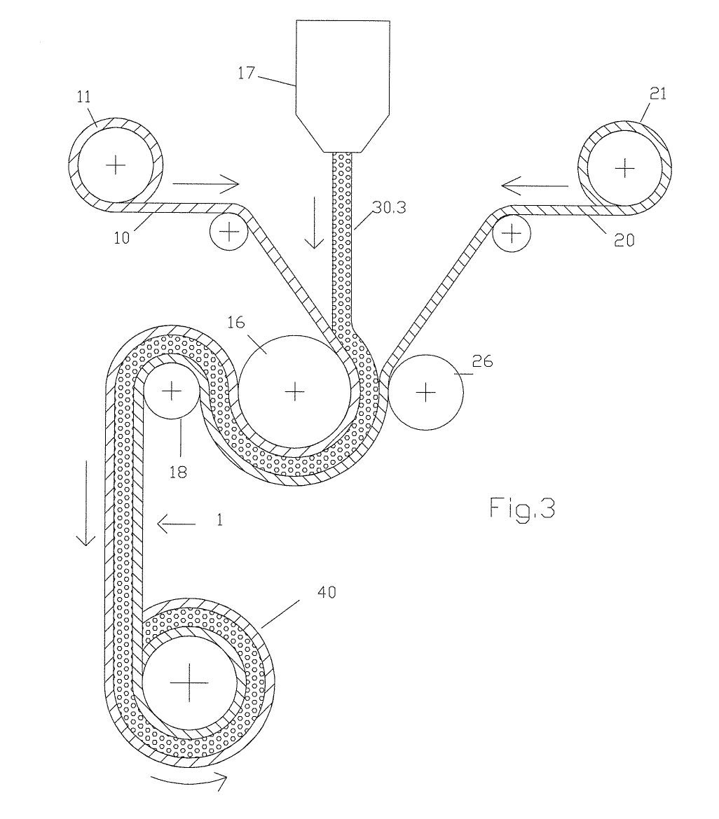

FIG. 3 illustrates a method for producing a multilayer material 1 using an extrudable coating substance as listed for example in one of the examples C. In this case too, cover layers 10 and 20 are unrolled as continuous webs from a roll 11 or 21, but then brought together in the gap between a chill roller 16 and a pressing roller 26. Coating substance 30 is forced out of an extruder 17 and introduced between the two cover layers as a hot curtain 30.3 with a flat sheet die and it comes into contact with cover layer 10 slightly sooner than with cover layer 20. The heat in the coating substance together with the pressure created by rollers 16 and 26 is sufficient to create the desired bond between the cover layers. The multilayer material 1 is quickly cooled down to room temperature by the large chill roller 16 and possibly additional cooling sections not shown here. Having been solidified in this way, it is advanced for winding at 40 via the take-off roller or fed directly to further processing. Unlike the multilayer material of FIG. 1, the multilayer material in this case includes a uniform layer 30 of coating substance, that is to say this layer of coating substance is not joined from several partial layers that may possibly be separated from each other again like layers 30.1 and 30.2. However, a coating substance 30 made up of multiple plies or several different plies may also be created in an extrusion system by an appropriate combination of several dies allocated to one or more extruders.

Besides additional substances for coloring, mechanical and optical properties and similar, and other functional additives, the extrudable coating substance used for the method according to FIG. 3 also includes a basic component of thermally activated adhesive. These components are not flowable at room temperature and are compounded and mixed into a homogenous, flowable coating substance by steadily increasing pressure and heat in extruder 17, which is preferably a twin screw extruder. The flowability required for coating is thus achieved without the use of water or organic solvents.

Extrusion lamination offers the following advantages:
The single-stage process, in which all components are mixed in a process called compounding mainly by gravity-fed dispensing into the twin extrusion screw, which promotes homogeneity and the consistently even mixing temperature for consistent flow behavior and thus also helps to ensure a close thickness tolerance of the coating. Aqueous or solvent-containing coatings may also be mixed in-line and fed to the coating system, but this requires additional expensive installations and is associated with significant cleaning effort;
The high temperature of extrusion renders the application of additional heat to activate the thermally activated adhesive unnecessary.
A coating made up of multiple plies or multiple different plies may be created in elegantly simple manner by combining different dies from one or more extruders.
The method is advantages for tie layers, for the purpose of reliably bonding more difficult cover layers such as oriented polypropylene or also for additional functional layers in line.

In comparison, extrusion lamination systems with one or two oppositely arranged dies (in order to coat 2 cover layers) are more expensive than systems that process aqueous or solvent-containing liquids. Given approximately the same widths and speeds, extrusion lamination is therefore better suited to manufacturing larger quantities. For smaller quantities, liquid coating is more economical.

With the methods of FIG. 2 and FIG. 3, only one pass is required to produce a multilayer material 1 according to the invention. However, it would also be possible to divide the method into a coating and a laminating phase, in which case the cover layers would be rolled up for intermediate storage at the end of the coating phase. The pre-coated cover layers would then only be joined to form a multilayer material according to the invention in a lamination step that is carried out at a different time and possibly a different place, possibly even by a different processor. The advantage of such a two-stage production process is that it would provide greater flexibility in terms of effectively constructing the multilayer material over a prolonged period of time and the process could be better adapted to the respective requirements of the end product to be created therefrom. The coated cover layers would be saleable semi-finished goods in their own right until they were bonded together. In addition, only one coating and—in the case of coating substances on an aqueous or solvent-containing base-one drying facility would be needed for the coating process. On the other hand, the disadvantage would be that the heat energy that was present in the coating substance and used by the drying and melting process and for the laminating process in the methods according to FIGS. 2 and 3 would be lost.

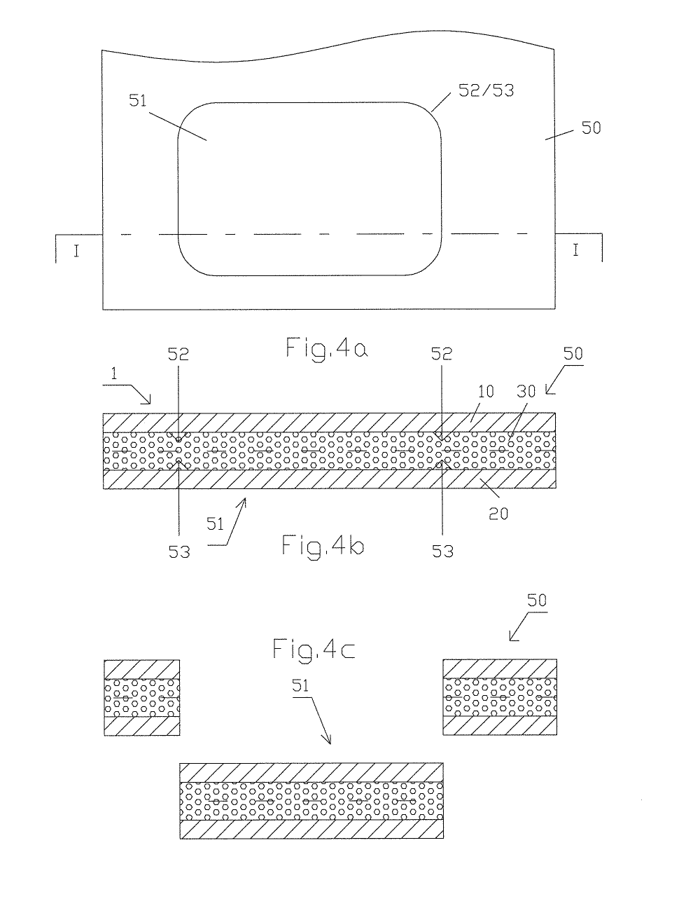

FIG. 4 shows an application of a multilayer material according to the invention in which a detachable card is integrated therein as a punched part. FIG. 4a shows a plan view of a section of a multilayer material 1 according to FIG. 1, which will be referred to in the following as printing stock 50, since in this context it will practically always be printed with the card as a saleable object. The card is identified with number 51 in FIG. 4a. In cross section (along line I-I in FIG. 3a), FIG. 4b shows the punch lines that are created to produce card 51, indicated by arrows 52 and 53. Accordingly, printing stock 50 is punched from both sides by punch parts 52 and 53, that is to say it is punched around its entire periphery, punch lines 52 and 53 being essentially applied congruently. Cover layers 10 and 20 are fully cut through, whereas at least sections of coating substance 30 are only partially cut, leaving a remaining thickness. Such type of cutting/punching is often also referred to as die-cutting or even kiss-cutting. Card 51 remains still attached to the material of printing stock 50 surrounding it via this remaining thickness. Modern punching machines have a tolerance of less than +/−5 μm. If the cover layers are always to be completely punched through, the tolerance field must lie entirely within the coating substance. In the worst case, a tolerance field of twice 10 μm results in a remaining thickness which is the coating substance thickness minus 20 μm, in the best case, with full compensation of both tolerance fields, the remaining thickness becomes equal to the coating substance thickness minus 0 μm. For an assured complete cutting through of the cover layers the tolerance field should even be located a few μm distant from the cover layer/coating substance contact line.

The remaining thickness of coating substance 30 may be severed along punch lines 52/53 by exerting pressure on card 51 and card 51 may be detached from printing stock 50. FIG. 4c shows printing stock 50 with card 51 detached.

The force necessary in order to detach card 51 from printing stock 50 should be as low as possible, but at the same time sufficient to ensure that card 51 does not become prematurely detached from printing stock 50 before it is intentionally separated when printing stock 50 is in proper use. In particular, the printing stock should be capable of being handled and/or processed mechanically and particularly of being printed in sheetfed printers with roller rerouters without card 51 becoming detached. If both cover layers 10 and 20 are fully cut through by cutting lines 52 and 53, the retaining force for card 51 is determined solely by the remaining thickness in coating substance 30 referred to earlier. The respectively appropriate retaining forces may thus be adjusted by selecting the composition of the coating substance and particularly by setting a suitable tear strength thereof including the “tear propagation resistance” to the desired value with sufficient precision. Coating substance 30 should also “stretch” as little as possible when the card is detached, so that the detached card has a smooth outer border above all defined by the cut borders of the two cover layers 10, 20.

In general, a length-related retaining force along the two congruent punch lines 52/53 of 1N/cm-3 N/cm is favorable. A value in this range is easily achievable with coating substance 30 according to the invention, even if the thickness of the coating substance is 75 μm or even up to 450 μm as in the example presented earlier. With a layer made from a plastic film of polyester, such as is preferably used for at least one of the two cover layers 10 or 20, or also with a paper layer, the remaining thickness necessary to achieve a comparable retaining force would be at least an order of magnitude smaller and would only be a few μm, and the retaining force would depend critically on the remaining thickness. Due to the limitations of the technology, it is not possible to punch and leave such small remaining thicknesses with the necessary degree of accuracy. When punching simultaneously, there would also be the danger that the opposing punch blades would collide and damage one another irreparably. All this is avoided with the coating substance according to the invention. Punching may be carried out on both sides with a single punching unit by passing the multilayer material between two magnetic cylinders having two identical but inverted sheet steel punch plates. Then, symmetrical punching must be assured by adapting the heights of the plate bases for forced centering of the multilayer material to avoid punched indentations of different depths. This is particularly important if the cover layers on either side are different and thus have different punch resistances. However, on a modern system it is possible to process first just one side on a punching unit and then the other side on a following punching unit with sufficient register accuracy in a single pass with the aid of a web traction adjustment with edge control of the material web, or simply with register control of the punch lines. Laser cut indentations are also possible, with even more accurate depth adjustment than with mechanical tools and punch units. Large remaining thicknesses of at least 25 μm are possible with the coating substance according to the invention, and the remaining thickness in question only has to be accurate to a tolerance of +/−25%, which is well within the usual tolerance range for standard commercially available punching equipment. Position tolerances for the two punch lines 52 and 53 relative to one another are also possible for the same reasons, that is to say they do not need to be exactly congruent, although of course that is preferable.

The “grip” of printing stock 50 overall and of card 51 is determined mainly by overall thickness D and the bending stiffness of the multilayer material used. As was mentioned previously, bending stiffness may be varied and adjusted to the desired value depending on the choice of composition of coating substance 30. For printing stocks with integrated cards as well as for the cards themselves, a bending stiffness is generally adequate if it is approximately equivalent to 70% of the bending stiffness of an oriented plastic film having the same overall thickness D from a material such as is used for at least one of the two cover layers 10 or 20. In particular, a multilayer material with bending stiffness in the range from 70% of the bending stiffness of a 175 μm thick standard commercial oriented polyester monolayer film. Such a polyester film has a bending stiffness between 0.04 N/25 mm and 0.05 N/25 mm, measured as the horizontal tensile force that must be exerted to bend a vertically clamped test part with a free end of 25×25 mm through 30°.

FIG. 5 shows a further preferred application of a multilayer material according to the invention of FIG. 1 for producing a different printing stock 60, comprising two partial print stock items that are formed on one side by a portion 61 of a multilayer material according to the invention and on the other side by a sheet of paper 66. As is shown in FIG. 5a, one of the two cover layers 20 together with ply 30.2 of the coating substance that was applied in a method according to FIG. 2 is separated along a border strip 62 of the multilayer material. In order to remove the strip identified with the number 63, the multilayer material must be scored along 64. In order to remove strip 63, it is also essential that it be possible to separate the multilayer material along the boundary surface between the two plies 30.1 and 30.2 of coating substance 30. By selecting the composition of the coating substance and by managing the method, for example in a method as shown in FIG. 2, the “separation index” for the two plies 30.1 and 30.2 with respect to and from one another may be suitably adjusted. A value in the range from 2 N-4 N/50 mm is usually suitable.

To ensure that detachment takes place along the boundary surface between plies 30.1 and 30.2, this separation value must be lower than the separation value for the two plies relative to their respective cover layers 10 and 20. If plies 30.1. and 30.2 have each been applied on cover layers 10 and 20 as shown in FIG. 2 and only brought into contact with one another afterwards, this will usually be the case. If separation along one of the two cover layers is desired, this may be achieved for example by applying all of the coating substance to just one of the cover layers, in which case the adhesion of this cover layer will usually be stronger than that of the other cover layer. In order for separation to occur at a given boundary surface due to “adhesion failure”, the internal cohesion of the coating substance must also generally be higher than the separation value on this boundary surface. However, it would also be possible to provide a break of cohesion, wherein it would be quite possible to consider a rupture between the two plies 30.1 and 30.2 of the coating substance as a cohesion failure in the coating substance as well.

The structure illustrated in FIG. 5a with a protruding border strip 62 is also obtained if one offsets cover layers 10, 20 laterally with respect to one another or uses cover layers having different widths for example in a method as illustrated in FIG. 2 or FIG. 3 for example, but particularly in a two-stage process with separate coating and lamination. In this case, the previously described requirements regarding separability of the multilayer material would also be dispensed with advantageously.

FIG. 5b shows paper sheet 66, whose thickness is reduced along a border strip thereof 67, wherein this has been effected by tearing off a strip 68 corresponding to a partial layer of the sheet of paper. The paper tear is indicated by a zigzag line on the tear surfaces. The width of border strip 67 corresponds to that of border strip 62 and is equal to 5-7 mm for example.

FIG. 5c shows section 61 of the multilayer material and paper sheet 66 along the border strip 62 and 67 with mutual overlapping thereof essentially coplanar with one another and attached to printing stock 60, which may form a sheet in a standard size such as A4 or Letter format. In this case the bond is an adhesive bond, wherein coating substance ply 30.1 is used as the adhesive.

The use of this existing ply to bond the two partial print stock items 61, 66 is possible if the thermally activated adhesive contained in the coating substance is activatable more than just once by the application of heat and pressure. A first activation of this adhesive was “used up” as described previously when the multilayer material was manufactured. However, most thermally activated adhesives, including those described in the preceding examples, have this property, that is to say they are capable of repeated activation.

The use of coating substance ply 30.1 as the adhesive means that the application of an additional adhesive to bond the two partial print stock items 61, 66 may advantageously be omitted. The adhesive contained in coating substance ply 30.1 only needs to be heated while the two border strips 62, 67 are pressed together. Activation of coating substance 30.1 preferably takes place in the border strip through hot air jets directly before the pressing step. Heated friction or rotating contact elements are also possible, as are even newer technologies such as contactless high frequency fields of ultrasonic sonotrodes. Accordingly, more expensive heating rollers are not required. Thus, the existing cold pressing rollers such as would be necessary if an additional adhesive were used are sufficient. Except for additional adhesive, this also obviates the need for an application mechanism for such an additional adhesive.

With printing stock 60 shown in FIG. 5c, another card 65 corresponding to card 51 of FIG. 3 is also punched in the multilayer material. Thus, FIG. 5c also shows an example of how the advantages of the multilayer material according to the invention may be combined to produce integrated cards with an inexpensive paper material in a sheet-like printing stock, wherein this functions quite satisfactorily entirely without the former customary add-ons to create the card and otherwise does not exhibit any thickness inconsistencies even in the overlap area that might cause a stack containing several such printing stocks to begin tilting, and are able to receive printing of the full surface and on both sides at any time, is in contrast to card attachments.

The production of the two partial print stock items 61 and 66, the removal of border strips 63 and 67, their mutual bonding to form printing stock 60 and/or the punching of cards 51 and 65 preferably take place in an endless continuous web process, like the production of the multilayer material according to the invention. These may be carried out in the same pass and also printed and/or separated into single sheets by cutting to size. In this context, punching, printing and separating must take place in the register.

Instead of tearing off a strip such as strip 68 in FIG. 5b, the thickness of the sheet of paper might also be reduced by compressing the paper material along the border corresponding to the width of a strip. Such compression has been described in the context of a continuous process in U.S. Pat. No. 4,447,481, a device with two press rollers for pressing also being described in that document. One of the two rollers is equipped with a rotating, strip-like raised area. However, such specialized equipment, which is used for continuous production of printing stock of the kind represented in FIG. 5 is not usually present in “web-finishing” firms. The punching machines that are standard there are equipped with magnetic and counter cylinders. Punching plates equipped with narrow punching knives are magnetically attached to the magnetic cylinder as required. The punching plates typically have a base thickness of about 120 μm and only extend over part of the circumference of the magnetic cylinder. On the other hand, however, closed rings are difficult to mount on and remove from the magnetic cylinder. Even so, it would be conceivable to use an expansion shaft in the existing punching devices, which would be able to support continuous pressing rings, though the magnetic cylinder would then have to be mounted instead of such an expansion shaft as needed, which would entail considerable effort. Moreover, expansion shifts with the requisite degree of precision are extremely expensive components.

However, the existing devices with magnetic and counter cylinder could also be used for strip-like compression of continuous paper webs by even independently adopting these inventive steps, either singly or in any combination thereof:
As for punching, magnetically attachable steel plates are used on the magnetic cylinder, preferably with only one plate on each magnetic cylinder, which plate may be bent into an essentially closed, but still open ring.
Instead of narrow punching ridges, these plates are equipped with a considerably wider, raised pressing strip.
For the plates overall, for example, a width of 50-100 mm is suitable.
To avoid excessive local loading of the magnetic cylinder caused by pressing in the area of the raised pressing strip, the compression forces created area distributed over a relatively larger area by equipping the plates with a base of 200-300 μm, thicker than the punching plates.
With a standard clearance gap of 580 μm between the magnetic and the counter cylinders, the overall thickness of the plate in the area of the compression strip is selected such that full use is made of the compressibility of the respective endless paper web. For example, a sheet of form paper weighing 140 g and having a thickness of 180 μm can be compressed with a pressing plate elevated to 0.550 mm high to a thickness of 120 μm.
The lateral flanks of the pressing strip are inclined at an angle between 70°-90° relative to the base of the panel.
The lateral edges of the pressing strip are also preferably rounded and have a radius of approximately 0.1-0.2 mm, to prevent them from cutting into the paper at the compression edge, wherein this becomes more critical as the flanks become steeper.
The surface width of the pressure strip may correspond to the width as was indicated above for border strips 62 and 76 and strips 62 and 68, and accordingly may be 5-7 mm plus for example 2 mm to ensure that the edge of the paper web is also compressed without fail.
With the cited dimensions, however, the plates are so stiff that, unlike the normal punching plates, they no longer readily bend out of a flat position and/or when bent their ends do not hug the magnetic cylinder tightly enough, so that particularly the ends project away from the magnetic cylinder. To solve this problem, the plates are therefore made from spring steel or plates with similar behavior, and are bent in advance, in fact to a smaller radius than the radius of the magnetic cylinder, so that they must be slightly bent open for mounting on the magnetic cylinder. The prior bending should particularly be more pronounced at the ends of the plates than over the rest of the circumference, so that they do not lift away from the circumference. A continuous pressing plate also requires a slightly higher shortening factor than a continuous punching plate because of its larger raised area.
In that the embossing plates form an only essentially closed, but still open ring, a gap inevitably results between the transverse edges thereof, which can be kept smaller than 0.2 mm. In order to avoid that this gap creates an impact at any point relating to the width of the embossing plates at the same time, the transverse edges of the plates are preferably cut at an angle, preferably an angle of 30°. Thereby, the gap is distributed over a certain unfolding length of the embossing plates. Thus, an almost continuous pressing takes place. In the worst case, a failure in the continuous pressing in the range of <0.2 mm is present diagonally to the direction of advance after each full plate length, which however does not considerably mitigate the effect of material thinning, the less so since that failure may take place outside of the finished item cut to final size (in the scrap), where its appearance is no longer irritating.

The production of printing stock 60 as shown in FIG. 5c might be performed as part of the previously described, two part method, also in conjunction with the lamination of two previously coated cover layers. For this, two previously coated cover layers and a paper web would have to be directed towards the laminating unit. In this case, the compression of the paper web to form a coplanar bond between the two partial print stock items may also be carried out previously in the same pass, but possibly also at the laminating station.

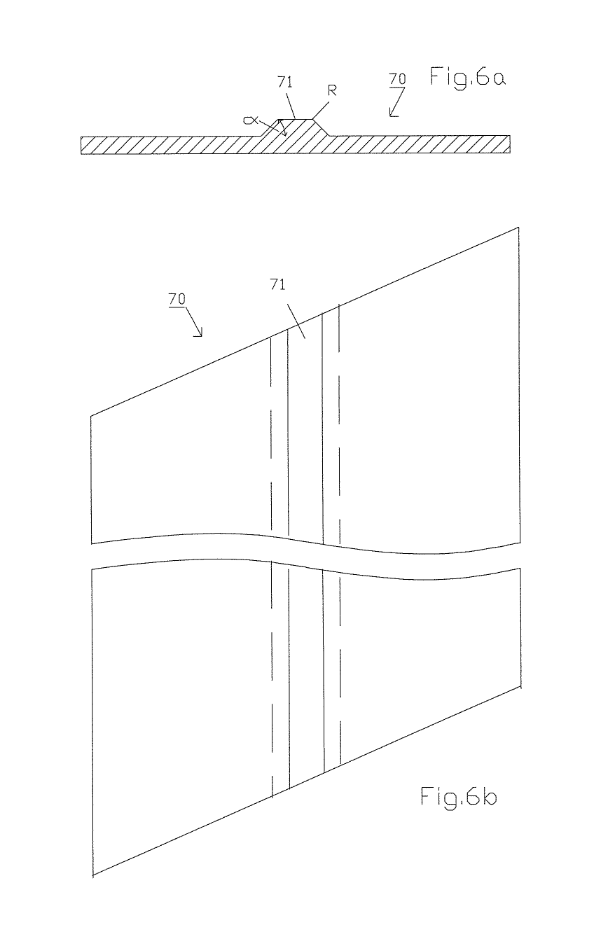

FIG. 6 shows in inset a) a cross sectional view and in inset b) a plan view of plate 70 having the features cited previously, wherein raised pressing strip is designated with legend number 71. The lateral flanks of pressing strip 71 are inclined towards the ground at a flank angle α of 70°, but they also function perfectly well at 90° simply by virtue of the distribution of pressure in the direction of running over the thicker base height. The edges of press strip 71 are somewhat rounded (radius R). The 30° cross section of the compression plate cross member takes each point of the cross member through the geometry of the impact in the direction of running towards the magnetic cylinder. This effect is approximately proportional to this angle, enlarging the angle increases the positive effect but makes them more difficult to produce and handle during installation.

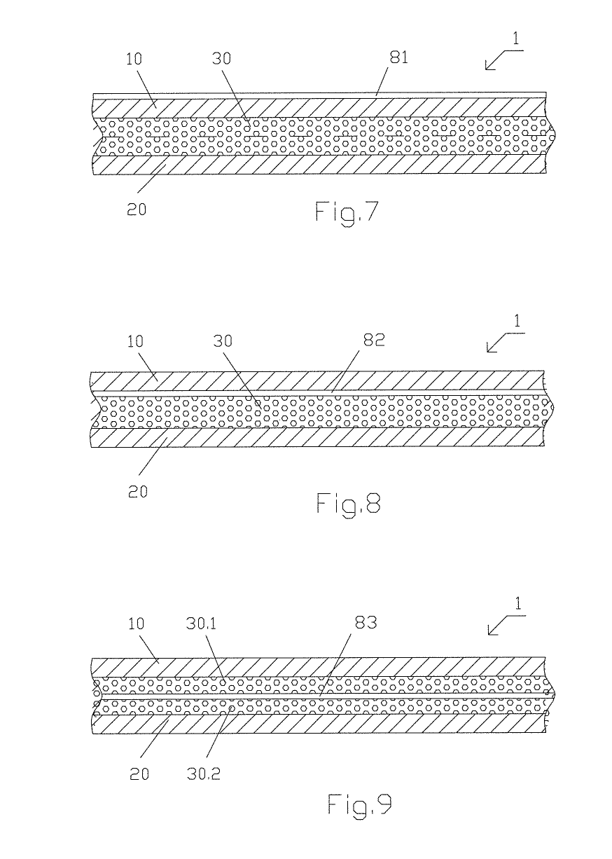

FIGS. 7, 8 and 9 show examples of modified embodiments of multilayer material 1 of FIG. 1.

In the case of the multilayer material of FIG. 7, a print layer 81 is applied to cover layer 10 to ensure that printing ink or toner adheres well is applied to cover layer 10. Layer 81 might alternatively or additionally also cause matting, be heat-reflective and/or have membrane properties. The opacity of the multilayer material might be increased by the addition for example of the components #3, #4, #5 and/or #6 used in the examples. A corresponding layer might also be provided on the cover layer 20.

In the case of the multilayer material of FIG. 8, an adhesive layer 82 is present between cover layer 10 and coating substance 30, which creates a stronger bond between cover layer 10 and coating substance 30, and might be used for example if the entire coating substance is applied only to cover layer 20. A corresponding layer might also be provided between cover layer 20 and coating substance 30 or between two plies of coating substance. For example, it may be a thermoplastically activated adhesive layer or a pressure sensitive adhesive (PSA).

In the case of multilayer material of FIG. 9, a further functional layer 83 is present between the two plies 30.1 and 30.2 of the coating substance, and the functionality thereof may be of various kinds, for example heat conducting, or heat insulating, or electrically insulating or conductive, thermally resistant, flame retardant, antibacterial, containing, absorbing or emitting liquids or fragrances, and/or chemically reactive. Layer 83 does not necessarily have to be single-ply and also does not have to be arranged between the plies 30.1 and 30.2. The coating substance itself or a ply of the coating substance might also exhibit corresponding functionalities if suitable substances were added thereto, in which case layer 83 might also be dispensed with.

As has been indicated, the multilayer material according to the invention is preferably produced and processed in a continuous process, in which for example punch elements are operated in the cycle by a punching tool to produce punched parts such as card 65 in printing stock 60 shown in FIG. 5c. In addition, the punched parts thus produced must subsequently often be provided with a distinctive feature in the cycle by another tool, which feature requires a positioning within specified limits. This positioning may be made considerably easier if markings arranged without tolerances relative to the punched parts are blanked in the multilayer material with the punching tool, and these markings are used to incorporate the cited feature. The markings may particularly be edges that are blanked for example by separating serrated border strips on a continuous strip. Together with punching the punched parts, a continuous web might also be divided into sheets, and the outer sheet borders would then be usable as marking edges. The feature to be incorporated may be for example a code on a magnetic strip extending over the punched parts or the inclusion of a chipcard module, the attachment of a material layer and/or a variable position label.

Having described the invention, it will be apparent to those skilled in the art that alterations and modifications may be made without departing from the spirit and scope of the invention limited only by the appended claims.

1. A multilayer material comprising two bearing cover layers having a combined bearing cover layer thickness and an amorphous coating substance between said two bearing cover layers, said multilayer material having an overall thickness (D) in the range of 100-800 μm,
wherein at least one of said two bearing cover layers is an at least translucent, oriented plastic film,
wherein said amorphous coating substance comprises an adhesive and includes an amorphous coating substance thickness and contributes at least 30% to said overall thickness,
wherein said adhesive is capable of being activated at least once by heat and pressure, said adhesive not being sticky at room temperature.

2. The multilayer material as recited in claim 1 wherein the other of said two bearing cover layers is selected from the group consisting of an at least translucent, oriented plastic film, a metal film, a paper layer, and a combination thereof.

3. The multilayer material as recited in claim 1, wherein said plastic film is selected from the group consisting of a polyester film, a polypropylene film, a polycarbonate film and a polyimide film.

4. The multilayer material as recited in claim 1, wherein said combined bearing cover layer thickness does not contribute more than 150 μm to said overall thickness (D).

5. The multilayer material as recited in claim 1, wherein said amorphous coating substance bonds said two bearing cover layers directly with one another.

6. The multilayer material as recited in claim 1, wherein said adhesive comprises a base selected from the group consisting of acrylate, polyurethane, polyester, epoxy resin, ethylene vinyl acetate, ethylethylene acrylate and any combination thereof.

7. The multilayer material as recited in claim 1, further comprising at least one admixture incorporated in said adhesive to increase the rigidity, opaqueness, whiteness, thermal conductivity, electrical conductivity, heat resistance, flame retardancy, the ability to maintain, absorb or emit liquids or fragrances and chemical reactivity of said amorphous coating substance as compared to said amorphous coating substance without said at least one admixture.

8. The multilayer material as recited in claim 7, wherein said amorphous coating substance contains 25-69% by weight adhesive and 31-75% by weight admixtures to said adhesive.

9. The multilayer material as recited in claim 7, wherein said at least one admixture comprises at least one bulking agent selected from the group consisting of carbonates, oxides, silicates, sulfates, fibers and lightweight bulking agents.

10. The multilayer material as recited in claim 1, wherein said two bearing cover layers have a tear strength and said amorphous coating substance has a tear strength at room temperature not more than 25% of the average value of the tear strength of said two bearing cover layers.

11. The multilayer material as recited in claim 1, wherein said multilayer material is separable within itself by a separating force and, wherein said separating force is preferably less than 5 N/50 mm.

12. A method for producing a multilayer material in a continuous process on a roll as the multilayer material is defined in claim 1, said method comprising the steps of:
unwinding each of said two bearing cover layers from a continuous web roll,
applying said amorphous coating substance to at least one of said two bearing cover layers
drying out said amorphous coating substance with the aid of heating;
bonding together both of said bearing cover layers by activation of said amorphous coating substance with heat and contact pressure applied to said bearing cover layers; and
rolling up the multilayer material on said roll or further processing the multilayer material in the same pass.

13. The method as recited in claim 12, further comprising the step of applying said coating substance to said two bearing cover layers.

14. A printing stock having an integrated punched part, said printing stock having an overall thickness and comprising a section of said multilayer material as defined in claim 1,
said printing stock including within said section of said multilayer material at least partially congruent indentations for defining said integrated punched part, said at least partially congruent indentations fully cutting through said two bearing cover layers and partially cutting through said coating substance,
said at least partially congruent indentations leaving a remaining thickness of at least 25 μm between each other, and wherein said integrated punched part remains attached to said printing stock via said remaining thickness.

15. A printing stock comprising at least a first flat partial print stock item having a first overall thickness and at least a second flat partial print stock item having a second overall thickness, said first flat partial print stock item and said second first flat partial print stock item being joined in a coplanar manner,
said first flat partial print stock item having a first border strip, said first border strip having a first border thickness less than said first overall thickness;
said second flat partial print stock item having a second border strip, said second border strip having a second border thickness less than said second overall thickness;
wherein one of said first flat partial print stock item and said second flat partial print stock item comprises a multilayer material as defined by claim 1,
wherein said first flat partial print stock item is bonded to said second flat partial print stock item at said respective border strips.

16. The multilayer material as recited in claim 7, wherein said amorphous coating substance contains 39-56% by weight adhesive and 44-61% by weight admixtures to said adhesive.

17. The multilayer material as recited in claim 10, wherein said amorphous coating substance has a tear strength of 2.5-4.5 N/mm².

18. The method as recited in claim 12 wherein said step of applying said amorphous coating substance comprises applying said amorphous coating substance hot as extrudate to at least one of said two bearing cover layers.

19. The multilayer material as recited in claim 1, further comprising at least one admixture incorporated in said adhesive to decrease the density, thermal conductivity and electrical conductivity of said amorphous coating substance as compared to said amorphous coating substance without said at least one admixture.

20. The multilayer material as recited in claim 1, further comprising at least one admixture incorporated in said adhesive for containing, absorbing or emitting more liquids or fragrances, of said amorphous coating substance as compared to said amorphous coating substance without said at least one admixture.

21. The multilayer material as recited in claim 9, wherein said carbonates are calcium carbonate.

22. The multilayer material as recited in claim 9, wherein said oxides are titanium dioxide.

23. The multilayer material as recited in claim 9, wherein said silicates are kaolin and talc.

24. The multilayer material as recited in claim 9, wherein said sulfates are barium sulphate.

25. The multilayer material as recited in claim 9, wherein said fibers are glass fiber.

26. The multilayer material as recited in claim 9, wherein said lightweight bulking agents are hollow microspheres.

27. The multilayer material as recited in claim 1, further comprising at least one admixture incorporated in said adhesive for creating duroplasticity and antibacterial properties of said amorphous coating substance as compared to said amorphous coating substance without said at least one admixture.

28. The multilayer material as recited in claim 2, wherein said plastic film is selected from the group consisting of a polyester film, a polypropylene film, a polycarbonate film and a polyimide film.

29. The multilayer material as recited in claim 12 wherein said step of applying said amorphous coating substance comprises applying said amorphous coating substance in liquid or paste-like form on an aqueous or solvent-containing base to at least one of said two bearing cover layers.
